(19) United States
(12) Patent Application Publication
(10) Pub. No.: US 2009/0162748 A1
(43) Pub. Date: Jun. 25, 2009

(54) Battery Enclosure

(76) Inventors: Jiang Fan, San Diego, CA (US); Robert M. Spotnitz, Pleasanton, CA (US)

Correspondence Address: Lin Yu, 11597 Tree Hollow Lane, San Diego, CA, 92128, US

(21) Appl. No.: 12/136,051

(22) Filed: Jun. 10, 2008

Related U.S. Application Data
(60) Provisional application No. 61/015,187, filed on Dec. 19, 2007.

(51) Int. Cl. H01M 2/04; H01M 2/02; H01M 2/08; H01M 6/00

(52) U.S. Cl. 429/175; 429/176; 429/185; 29/623.2

(57) ABSTRACT

Provided herein is a battery enclosure which comprises a flexible tubular battery housing having a top and bottom open end, and a top and bottom end plug, wherein the top and bottom end plugs are attached to the top and bottom open ends of the tubular battery housing, respectively, thus forming a sealed battery enclosure for housing a battery cell.

### CROSS-REFERENCE TO OTHER APPLICATION

This application claims the benefit of U.S. Provisional Application No. 61/015,187, filed on Dec. 19, 2007.

### FIELD

Provided herein is a battery enclosure which comprises a flexible tubular battery housing having a top and bottom open end, and a top and bottom end plug, wherein the top and bottom end plugs are attached to the top and bottom open ends of the tubular battery housing, respectively, thus forming a sealed battery enclosure for housing a primary or secondary battery cell.

### BACKGROUND

Batteries have become an essential power source in a wide range of portable electronic devices, including computers, personal information managers, cellular telephones, and global positioning satellite (GPS) devices. Their applications are expected to increase in the future as storage battery technology, particularly energy density, continues to improve. Accordingly, there is a continuing need for a battery enclosure that is light in weight, cost effective, and readily manufactured.

### SUMMARY OF THE DISCLOSURE

Provided herein is a battery enclosure which comprises a flexible tubular battery housing having a top and bottom open end, and a top and bottom end plug, wherein the top and bottom end plugs are attached to the top and bottom open ends of the tubular battery housing, respectively, thus forming a sealed battery enclosure for housing a primary or secondary battery cell. In one embodiment, the flexible tubular battery housing is made from a flexible film. In one embodiment, the flexible film is a multi-layer laminate. In another embodiment, the flexible film is a polymer film. In yet another embodiment, the flexible film is a composite material film.

In one embodiment, the top and bottom end plugs are made from a polymer. In another embodiment, the top and bottom end plugs are each independently tapered, cylindrical, or stepped. In yet another embodiment, the horizontal cross-sections of the top and bottom end plugs are each independently circular, semicircular, oval, triangular, square, or rectangular.

In one embodiment, the horizontal cross-sections of the top and bottom end plugs are both circular, and the flexible tubular battery housing is a cylindrical tube. In another embodiment, the horizontal crosssections of the top and bottom end plugs are square, and the flexible tubular battery housing is a tube in a square prism. In yet another embodiment, the horizontal cross-sections of the top and bottom end plugs are rectangular, and the flexible tubular battery housing is a tube in a rectangular prism.

In one embodiment, the top or bottom end plug further comprises an elaborate seal, in one embodiment, a Ziegler seal. In another embodiment, the top or bottom end plug further comprises one or more electrical posts, in one embodiment, one or two electrical posts. In yet another embodiment, the top or bottom end plug further comprises one or more safety devices, in one embodiment, one or two safety devices. In one embodiment, the safety device is a positive temperature coefficient device or a current interrupt device.

In one embodiment, the battery enclosure provided herein further comprises a center support with a top and bottom end, wherein the center support is attached to the top end plug via its top end and/or the bottom end plug via its bottom end.

Also provided herein is a battery which comprises a battery cell and a battery enclosure provided herein, wherein the battery cell is housed within the battery enclosure. In one embodiment, the battery cell is a primary cell. In another embodiment, the battery cell is a secondary cell.

Further provided herein is a method of sealing a top or bottom end plug to a flexible tubular battery housing, which comprises applying an outer cylinder to the side wall of the open end of the battery housing to be sealed, and an inner cylinder to the side wall of the indent of the end plug to be sealed. In one embodiment, the outer or inner cylinder is heated. In another embodiment, the axes of the outer and inner cylinders are parallel to the axis of the end plug to be sealed.

### BRIEF DESCRIPTION OF THE FIGURES

FIG. 1 is a cross-sectional view of a battery enclosure 1 provided herein, which comprises a flexible tubular battery housing 10 having a top and bottom open end (11 and 12), and a top and bottom end plug (21 and 22), wherein the top end plug 21 is attached to the top open end 11 and the bottom end plug 22 is attached to the bottom open end 12 of the tubular battery housing 10, thus forming a sealed battery enclosure 1.

FIG. 2 is a cross-sectional view of a cylindrical tubular battery housing 10 made from a multi-layer laminate 30 with three layers: an exterior polymer layer 32, a metal foil 31, and an interior polymer layer 33.

FIGS. 3 are perspective views of exemplar top and bottom end plugs, 21 and 22: A. a tapered plug 41; B. a cylindrical plug 42; and C. a stepped plug 43.

FIG. 4 is a cross-sectional view of a top end plug 21 with an indent 217 on its inner surface.

FIG. 5 is a cross-sectional view of a battery enclosure 1, wherein the top and bottom end plugs (21 and 22) each has an indent on either its outer or inner surface (216 or 217).

FIG. 6 is a cross-sectional view of a top or bottom end plug (21 or 22) attached to one open end (11 or 12) of a flexible battery housing 10 via a layer of adhesive 230.

FIG. 7 is a cross-sectional view of a tapered end plug 41 with a Ziegler seal 61, which can be used as either a top or bottom end plug (21 or 22).

FIGS. 8 are cross-sectional views of a tapered end plug 41 with: A. one electrical post 51; and B. two electrical posts, 51 and 52; either of which can be used as either a top or bottom end plug (21 or 22).

FIG. 9 is a cross-sectional view of a tapered end plug 41 having a Ziegler seal 61 and a positive temperature coefficient (PTC) device 72, which can be used as either a top or bottom end plug (21 or 22).

FIG. 10 is a cross-sectional view of a tapered end plug 41 having a current interrupt device (CID) 73, which can be used as either a top or bottom end plug (21 or 22). The current interrupt device 73 comprises a conductive flexible burst disk 731, which is attached to the bottom of the tapered plug 41, a hollow post 733 with its bottom end attached to the burst disk 731 and its top end extended outside the top surface of the tapered plug 41, and a tab 732 with one end attached to an electrode and the other end attached to the burst disk 731.

FIGS. 11 are cross-sectional views of a tapered end plug 41 having an electrolyte fill hole 75, which can be used as either a top or bottom end plug (21 or 22). After filling, the fill hole 75 can be sealed by: A. a ball 751; B. a rod 752, or C. a sheet 753.

FIG. 12 is a cross-sectional view of a battery enclosure 1 with a center support 81 with a top and bottom end, wherein the top end is attached to the top tapered end plug 21 and the bottom end is attached to the bottom tapered end plug 22 of the tubular battery enclosure 1 for supporting a jelly roll 90.

FIG. 13 is a cross-sectional view of a battery assembly in which four battery enclosures 1 are connected together via two connecting rods 100.

FIG. 14 is a cross-sectional view of a battery assembly which comprises a battery enclosure 1 and a jelly roll 90. The battery enclosure 1 comprises a flexible tubular battery housing 10, and a top and bottom end plugs (21 and 22). The top end plug 21 comprises a plug 210, and a post assembly 211 comprising an electrical post 51, a sealing nut 212, and 0-ring 213, wherein the post assembly 211 is secured to the plug 210 by attaching the sealing nut 212 to the outer end of the electrical post 51. The bottom end plug 22 comprises a plug 220 having a fill hole 75, and a post assembly 221 comprising an electrical post 51, a sealing nut 222, and 0-ring 223, wherein the post assembly 211 is secured to the plug 210 by attaching the sealing nut 212 to the outer end of the electrical post 51. The top end plug 21 further comprises a tab 732, which connects the top post assembly 211 to the jelly roll 90. The bottom end plug 22 further comprises a tab 732, which connects the bottom post assembly 211 to the jelly roll 90.

FIGS. 15 are cross-sectional views of a top or bottom end plug (21 or 22), comprising a post assembly 221 and a plug 220 having an indent on the inner surface of the end plug (21 or 22), wherein the post assembly 221 is embedded in the molded plug 220 (A) or the post assembly 221 is crimped to the plug 220 on the outer surface of the plug 220 (B).

FIG. 16 is a cross-sectional view of a top end plug 21 having a conventional battery header 95 embedded into the plug 210.

FIG. 17 is a cross-sectional view of a conventional battery header 95.

FIG. 18 is a cross-sectional view of a portion of an apparatus for sealing an end plug (21 or 22) to an open end (11 and 12) of a flexible battery housing 10.

### DETAILED DESCRIPTION

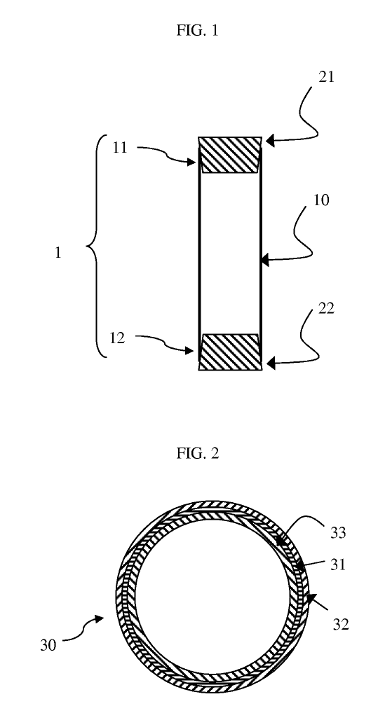

Provided herein is a battery enclosure 1, which comprises a flexible tubular battery housing 10 having a top open end 11 and a bottom open end 12, and a top end plug 21 and a bottom end plug 22, wherein the top end plug 21 is attached to the top open end 11 and the bottom end plug 22 is attached to the bottom open end 12 of the tubular battery housing 10, thus forming a sealed battery enclosure 1 for housing a battery cell (FIG. 1).

In one embodiment, the flexible tubular battery housing 10 is made from a flexible film. Suitable flexible films include, but are not limited to, metal foil, such as aluminum, nickel, copper, and stainless steel foil; a polymer; and a composite material. In certain embodiments, the metal foil film has a thickness from 1 μm to about 200 μm, from about 10 to about 100 μm, or from about 10 to about 50 μm, in one embodiment, of about 10 μm, about 20 μm, about 30 μm, about 40 μm, or about 50 μm.

In one embodiment, the battery housing 10 is made from a multi-layer laminate 30. In one embodiments, the multi-layer laminate comprises a metal foil 31, including, but not limited to, aluminum, nickel, copper, or stainless steel. In another embodiment, the metal foil 31 has a thickness from 1 μm to about 200 μm, from about 10 to about 100 μm, or from about 10 to about 50 μm, in one embodiment, of about 10 μm, about 20 μm, about 30 μm, about 40 μm, or about 50 μm.

In another embodiment, the multi-layer laminate 30 further comprises an exterior layer 32, which is attached to the exterior surface of the metal foil 31. In one embodiment, the exterior layer 32 is a polymer layer. In another embodiment, the exterior layer 32 is a scratch resistant polymer layer and thus functions as a protective layer for the metal foil 31. In yet another embodiment, the exterior layer 32 is made from polymer such as a nylon or polyester. In still another embodiment, the exterior layer 32 has a thickness from 1 μm to about 1 mm, from about 5 to about 200 μm, from about 10 to about 100 μm, or from about 10 to about 50 μm, in one embodiment, of about 10 μm, about 20 μm, about 30 μm, about 40 μm, or about 50 μm.

In yet another embodiment, the multi-layer laminate 30 further comprises an interior layer 33, which is attached to the interior surface of the metal foil 31. In one embodiment, the interior layer 33 is a polymer layer. In another embodiment, the interior layer 32 is a heat-seable polymer layer, including, but not limited to, polyolefins, such as polyethylene or polypropylene polymers, which melt when heat and pressure are applied and bond upon cooling. In yet another embodiment, the interior layer 33 has a thickness from 1 μm to about 1 mm, from about 5 to about 200 μm, from about 10 to about 100 μm, or from 10 about to about 50 μm, in one embodiment, of about 10 μm, about 20 μm, about 30 μm, about 40 μm, or about 50 μm.

An example of a three-layer laminate is illustrated in FIG. 2.

In another embodiment, the battery housing 10 is made from polymer film, including, but not limited to, nylon, polyester, and polyolefin (such as polyethylene or polypropylene) film. In one embodiment, the polymer film has a thickness from 1 μm to about 1 mm, from about 5 to about 200 μm, from about 10 to about 100 μm, or from 10 about to about 50 μm, in one embodiment, of about 10 μm, about 20 μm, about 30 μm, about 40 μm, or about 50 μm.

In yet another embodiment, the battery housing 10 is made from composite material film. In one embodiment, the composite material film has a thickness from 1 μm to about 1 mm, from about 5 to about 200 μm, from about 10 to about 100 μm, or from 10 about to about 50 μm, in one embodiment, of about 10 μm, about 20 μm, about 30 μm, about 40 μm, or about 50 μm.

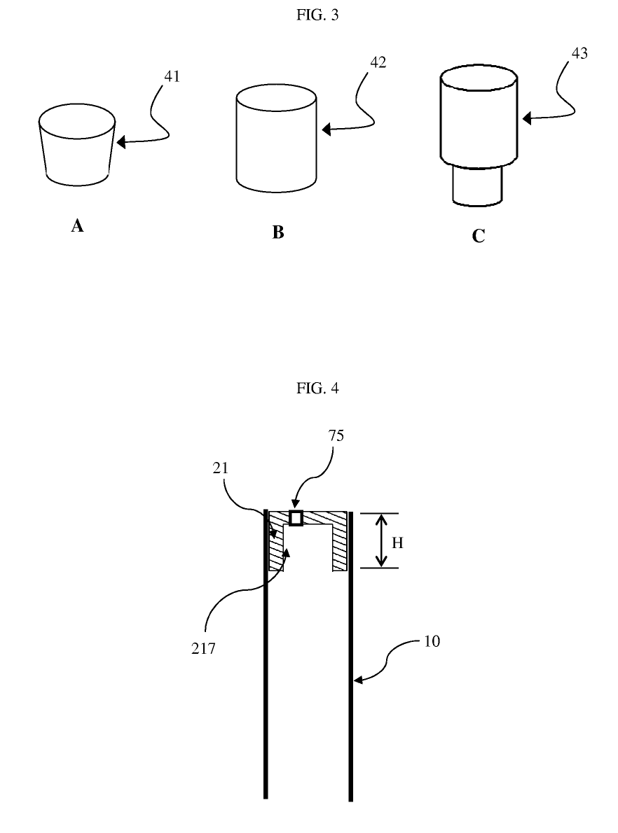

Both the top and bottom end plugs, 21 and 22, can have a variety of shapes. FIG. 3 illustrates some of the shapes contemplated herein, where the tubular battery housing 10 is a cylindrical tube. The top and bottom end plugs, 21 and 22, can each independently be tapered 41 (FIG. 3A), cylindrical 42 (FIG. 3B), or stepped 43 (FIG. 3C). Generally, the top and bottom end plugs, 21 and 22, have the same shapes. However, they can be different if so desired.

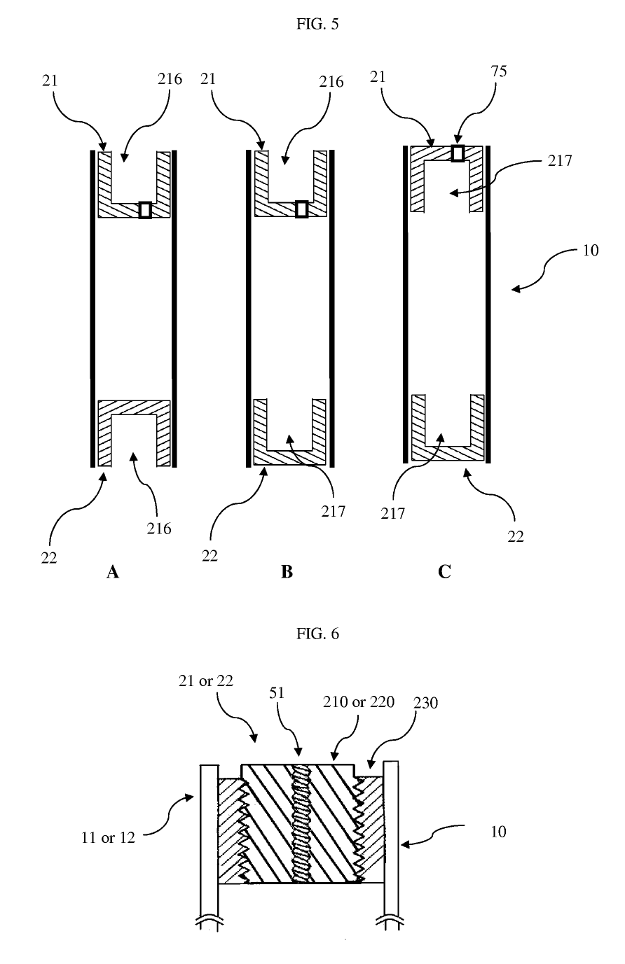

In certain embodiments, the top and bottom end plugs (21 or 22) each independently comprises an indent 216 on its outer surface and/or an indent 217 on its inner surface (FIGS. 4 and 5). In one embodiment, the top end plug 21 has an indent 216 on its outer surface. In another embodiment, the top end plug 21 has an indent 217 on its inner surface. In yet another embodiment, the bottom end plug 22 has an indent 216 on its outer surface. In yet another embodiment, the bottom end plug 22 has an indent 217 on its inner surface. In yet another embodiment, the top and bottom end plugs 21 and 22 each has an indent 216 on their outer surfaces. In yet another embodiment, the top end plug 21 has an indent 216 on its outer surface and the bottom end plug 22 has an indent 217 on its inner surface. In yet another embodiment, the top end plug 21 has an indent 217 on its inner surface and the bottom end plug 22 has an indent 216 on its outer surface. In still another embodiment, the top and bottom end plugs 21 and 22 each has an indented 217 on their inner surfaces.

The indent (216 or 217) on the top or bottom end plug (21 or 22) can have a variety of shapes. In certain embodiments, the indent (216 or 217) on either the top or bottom end plug (21 or 22) can each independently be tapered, cylindrical, or stepped.

In general, the shape of the indent (216 or 217) is the same as that of the plug (21 or 22). However, they can be different if so desired. In one embodiment, the indent (216 or 217) is cylindrical. In one embodiment, the top and bottom end plugs (21 and 22) are cylindrical. In another embodiment, the indents (216 or 217) on the top and bottom end plugs (21 and 22) are cylindrical. In yet another embodiment, the top and bottom end plugs (21 and 22) are cylindrical, and the indents (216 or 217) on the top and bottom end plugs (21 and 22) are also cylindrical.

The horizontal cross-sections of the top and bottom end plugs, 21 and 22, which are parallel to either its top or bottom surface can also be in a variety of shapes, including, but not limited to, circle, semicircle, triangle, square, rectangle, oval, hexagon, and combinations thereof. The horizontal cross-sections of the top and bottom end plugs, 21 and 22, together with the shape of a battery cell enclosed within the tubular battery house 10 determine the tubular shape of the flexible tubular battery housing 10, and thus the shape of the battery enclosure 1. In one embodiment, the horizontal cross-sections of the top and bottom end plugs (21 and 22) are circular, and thus the tubular battery housing 10 is a cylindrical tube and useful for housing a cylindrical battery cell. In another embodiment, the horizontal cross-sections of the top and bottom end plugs (21 and 22) are rectangular, and thus the tubular battery housing 10 is a rectangular tube and useful for housing a battery cell in the shape of a rectangular prism. If one of sides of the rectangle of the horizontal crosssections is substantially smaller than the other, a thin battery enclosure 1 is formed. In yet another embodiment, the horizontal cross-sections of the top and bottom end plugs (21 and 22) are square, and thus the tubular battery housing 10 is a square tube and useful for housing a battery cell in the shape of a square prism.

The top and bottom end plugs, 21 and 22, are used to provide seals with the top and bottom open ends, 11 and 12, of the flexible tubular battery housing 10, respectively. Thus, the horizontal cross-section of the top end plug 21 is designed to adapt to the size of the top open end 11 and the horizontal cross-section of the bottom end plug 22 is designed to adapt to the size of the bottom open end 12 of flexible tubular battery housing 10. The plug bodies (210 and 220) of the top and bottom plugs (21 and 22) are generally made from plastics, including, but not limited to, polyolefins. The top and bottom plugs, 210 and 220, are readily fabricated using techniques known in the plastics industry, e.g., injection molding. In one embodiment, the top and bottom plug bodies, 210 and 220, each independently further comprise a fire retardant material. In another embodiment, the top and bottom end plug bodies, 210 and 220, are each independently coated with a sealant polymer 230, such as polypropylene to enhance the seal (FIG. 6). In certain embodiments, the top and bottom end plugs, 21 and 22, each independently range in diameter from about 1 mm to about 100 cm, from about 5 mm to about 50 cm, or from 10 mm to about 10 cm, and in height from about 1 mm to about 20 cm, from about 1 mm to about 10 cm, or from about 2 mm to about 5 cm. In certain embodiments, the heights (H) of the top and bottom plugs 21 and 22 are each independently from about 1 to about 20 mm, from about 1 to about 5 mm, from about 5 to 10 mm, or from about 10 to about 20 mm.

In one embodiment, the end plugs (21 and 22) are attached to the open ends 11 and 12 of the flexible battery housing 10 via heating. In another embodiment, the end plugs (21 and 22) are attached to the open ends 11 and 12 of the flexible battery housing 10 using adhesive 230 (FIG. 6). Alternative methods of sealing known to a person of ordinary skill in the art are also contemplated, including, but not limited to, ultrasonic welding and high frequency welding.

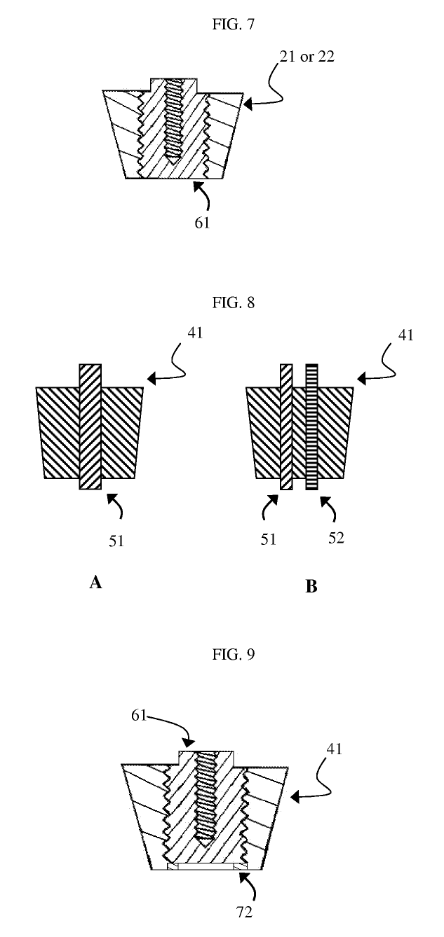

In certain embodiments, the top and bottom end plugs, 21 and 22, each independently houses an elaborate seal. In one embodiment, the elaborate seal is a Ziegler seal 61 (FIG. 7). Further suitable examples of elaborate seals can be found, for example, in U.S. Pat. No. 5,273,845, which is incorporated herein by reference in its entirety.

In certain embodiments, the top or bottom end plug (21 or 22) also houses one or more devices, such as an electrical post 51 carrying current to and from the battery and/or a safety device 71 to improve the abuse tolerance of the battery enclosure 1. In one embodiment, the top end plug 21 houses at least one electrical post 51. In another embodiment, the top end plug 21 houses one electrical post 51 (FIG. 8A). In yet another embodiment, the top end plug 21 houses two electrical posts, 51 and 52. In one embodiment, the bottom end plug 22 houses at least one electrical post 51. In another embodiment, the bottom end plug 22 houses one electrical post 51. In another embodiment, the bottom end plug 22 houses two electrical posts, 51 and 52. In certain embodiments, the two electrical posts, 51 and 52, are of opposite polarity (FIG. 8B).

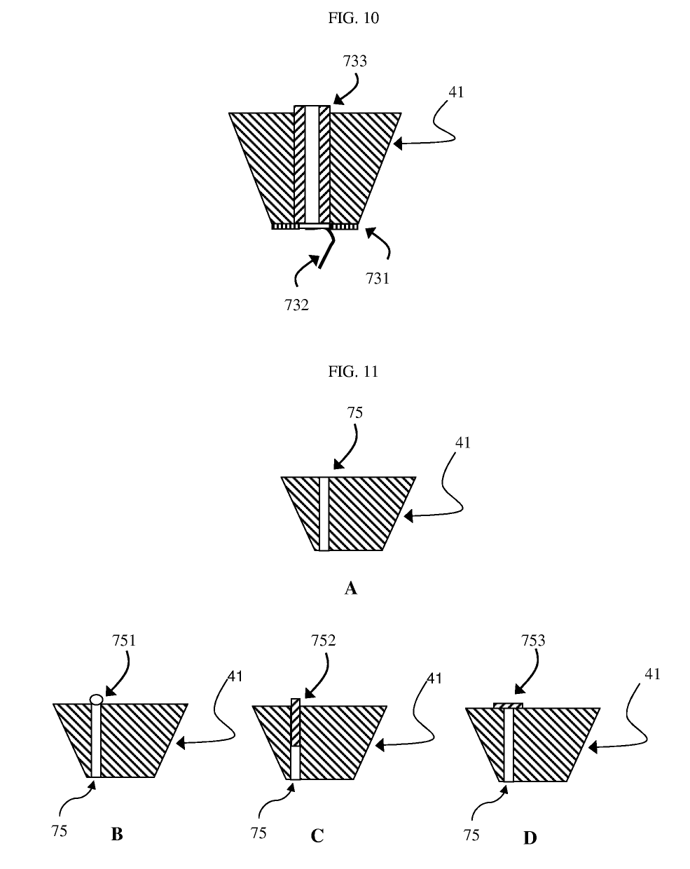

In yet another embodiment, the top or bottom end plug (21 or 22) also houses one or more safety devices 71 to improve the abuse tolerance of the battery enclosure 1. In one embodiment, the top end plug 21 contains one safety device 71. In another embodiment, the bottom end plug 22 contains one safety device 71. Suitable safety devices include, but are not limited to, positive temperature coefficient devices (PTC) 72 (FIG. 9), a current interrupt device (CID) 73, thermostat metal (such as, e.g., bimetal) switch, and memory metal thermal switch as described in U.S. Pat. No. 6,191,679, which is incorporated herein by reference in its entirety. An example of the CID 73 is illustrated in FIG. 10, which comprises a conductive flexible burst disk 731, a hollow post 733 with its bottom end attached to the burst disk 731 and the top end extended outside the plug (21 or 22), and a tab 732 with one end attached to an electrode and the other end attached to the burst disk 731.

In yet another embodiment, the top or bottom end plug (21 or 22) also houses an electrolyte fill hole 75 (FIG. 11A), which is used to fill the battery enclosed within the battery enclosure 1 with electrolyte after the top and bottom end plugs (21 and 22) have been sealed to the tubular battery housing 10. The fill hole can then be sealed with a ball 751, rod 752, or sheet 753 (FIGS. 11B to 11D).

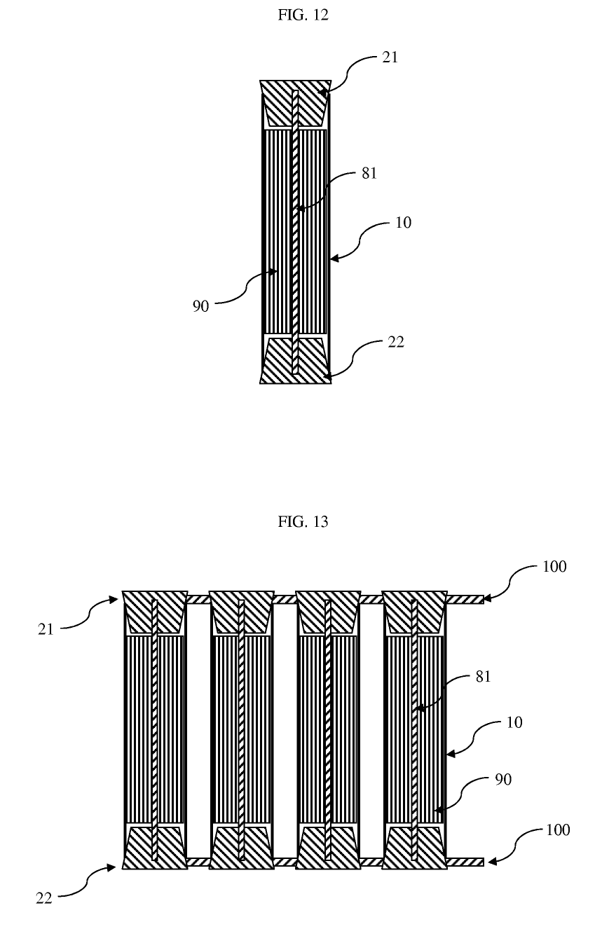

In yet another embodiment, the battery enclosure further comprises a center support 81 for a jellyroll 90 (FIG. 12), which has a top and bottom end. The center support can be either a tube or rod. A jellyroll 90 is a spirally wound assembly of electrodes and separators. A center support 81 is desirable to provide mechanical support for the jellyroll 90. The center support 81 can also be used to support the electrodes and separators during winding. In one embodiment, the center support 81 is attached via its top end to the top end plug 21. In another embodiment, the center support 81 is attached via its bottom end to the bottom end plug 22. In yet another embodiment, the center support 81 is attached via its top end to the top end plug 21 and via its bottom end to the bottom end plug 22. In yet another embodiment, the center support 81 is conductive, though which an electrical post (51 or 52) is connected electrically to one of electrodes of the battery housed within the battery enclosure 1. In yet another embodiment, one of the top and bottom end plugs (21 and 22) and the center rod 81 form as a unitary element, in order to provide mechanical stability, reduce the number of parts, and simplify winding. In one embodiment, the top end plug 21 and the center rod 81 form as a unit. In an alternative embodiment, the bottom end plug 22 and the center rod 81 form as a unit. In yet another embodiment, the center support 81 is thermally conductive. In still another embodiment, the center support 81 contains a fire retardant, such as calcium carbonate, which is released when the center support 81 melts.

In certain embodiments, connecting rods 100 are used to connect cells together in a “tinker toy” fashion (FIG. 13). In certain embodiments, the connecting rods 100 are electrically conductive and so enable battery cells to be connected in series and/or parallel.

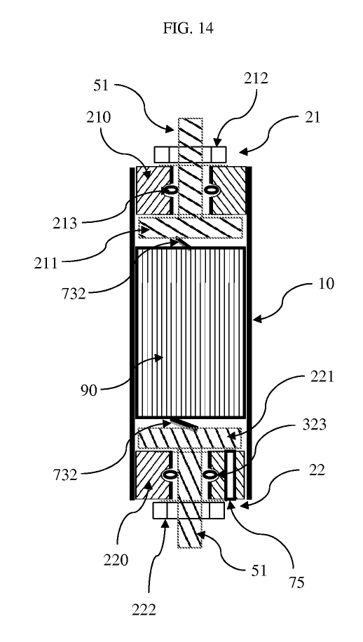

In one embodiment, provided herein is a battery assembly which comprises a battery enclosure 1 and a battery cell 90, such as a jelly roll (FIG. 14). The battery enclosure 1 comprises a flexible tubular battery housing 10, and a top and bottom end plug (21 and 22). In one embodiment, the top and bottom end plugs 21 and 22 each independently comprises a plug (210 or 220) and a post assembly (211 or 221). In one embodiment, the post assembly (211 or 221) comprising an electrical post 51 and a sealing nut (212 or 222), where the post assembly (211 or 221) is secured to the plug (210 or 220) by attaching the sealing nut (212 or 222) to the outer end of the electrical post 51. In another embodiment, the post assembly (211 or 221) further comprises a seal (213 or 223), such as O-ring or glass-to-metal seal 213 to assist the sealing of the post assembly (211 or 221) to the plug (210 or 220). In yet another embodiment, the top end plug 21 further comprises a tab 732, which connects the top post assembly 211 to the battery cell 90. In yet another embodiment, the bottom end plug 22 further comprises a tab 732, which connects the bottom post assembly 221 to the battery cell 90. In still another embodiment, the top or bottom plug (210 or 220) contains a fill hole 75.

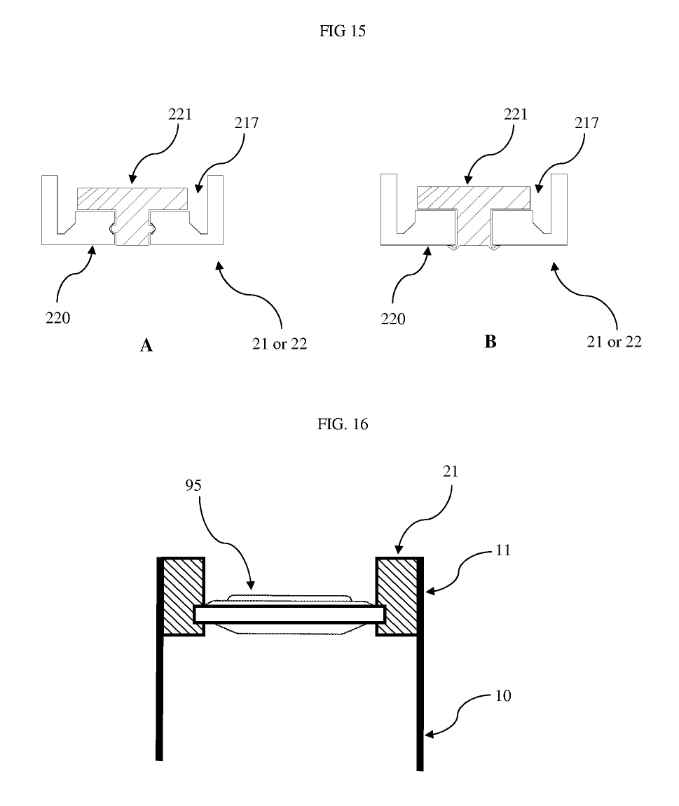

In an alternative embodiment, the post assembly (211 or 221) comprise an electrical post 51 which is embedded in the plug (210 or 220), e.g., during the formation of the plug, such as injection molding to form an elaborate seal (FIG. 15A). In another alternative embodiment, the post assembly (211 or 221) comprises an electrical post 51, which is crimped to the plug (210 or 220) to form an elaborate seal (FIG. 15B).

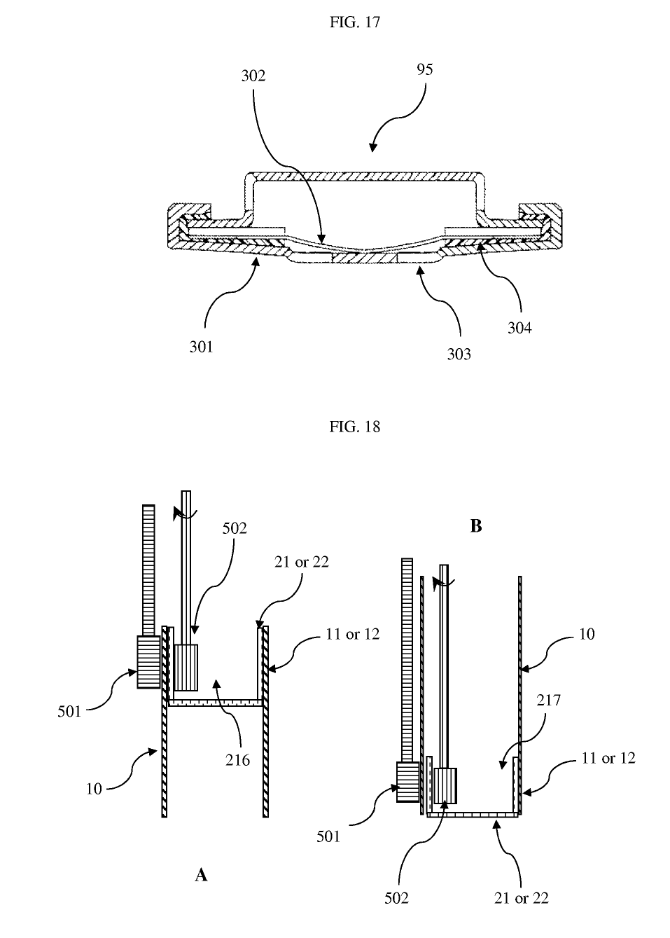

In certain embodiment, the top or bottom end plug (21 or 22) is adapted to accommodate a conventional battery header 95. As such, the post assembly 211 is a part of a conventional battery header 95, where the conventional battery header 95 is embedded into the plug 210 (FIG. 16). Further examples of conventional battery headers 95 can be found, e.g., in U.S. Pat. Nos. 6,210,824; 6,632,572, and 6,900,616; each of which is incorporated herein by reference in its entirety. In certain embodiments, the conventional battery header 95 may also comprise one or more safety devices, including, but not limited to, CID, PTC, and vents. In one embodiment, the conventional battery header 95 comprises an electrically conductive plate 301, a flexible conductive disk 302, a vent hole 303, and an insulator 304 (FIG. 17). Gas pressure generated in a battery cell communicates with the flexible conductive disk 302 through the vent hole 303 of the electrically conductive plate 301. The pressure causes the flexible conductive disk 302 to disconnect from the electrically conductive plate 301.

The flexible battery enclosure 1 provided herein is applicable to primary and/or secondary batteries, including, but not limited to, Li/MnO₂, Li/FeS₂, and Li/S cells. The flexible battery enclosure 1 provided herein is also applicable to many types of lithium ion batteries, including, but not limited to, LiFePO₄/graphite, LiCoO₂/graphite, LiMn₂O₄/graphite, and LiMn₂O₄/Li₄Ti₅O₁₂.

In certain embodiments, also provided herein is a method of sealing a top or bottom plug (21 or 22) having an indent (216 or 217) to the top or bottom end (11 or 12) of the flexible tubular battery housing 10. The method comprises applying an outer cylinder 501 to the side wall of the open end (11 or 12) of the battery housing 10 to be sealed, and an inner cylinder 502 to the side wall of the indent (216 or 217) of the end plug (21 or 22) to be sealed, thus pressing the end plug (21 or 22) and the open end (11 or 12) together. In one embodiment, the outer cylinder 501 is heated. In another embodiment, the inner cylinder 502 is heated. In one embodiment, the outer and inner cylinders (501 and 502) are heated. In yet another embodiment, the axes of the outer and inner cylinders (501 and 502) are parallel to the axis of the end plug (21 or 22) to be sealed (FIG. 18). The two cylinders (501 and 502) compress the end plug (21 or 22) and the open end (11 or 12) of the tubular battery housing 10 together. The heat and/or pressure of the two cylinders (501 and 502) seal the end plug (21 or 22) to the open end (11 or 12) of the tubular battery housing 10. In one embodiment, the outer cylinder 501 is motorized so that its rotation creates a seal along the entire diameter of the open end (11 or 12) of the battery housing 10. In another embodiment, the inner cylinder 502 is motorized so that its rotation creates a seal along the entire diameter of the open end (11 or 12) of the battery housing 10. In certain embodiments, the outer and/or inner cylinder 501 and 502 can heat the interface between the open end (11 or 12) of the battery housing 10 and the end plug 21 or 22 to a temperature ranging from about 130 to about 250° C., from about 180 to about 220° C., or from about 190 to about 200° C. The size of the inner cylinder 501 is adapted to the size of the indent (216 or 217). In certain embodiments, the diameter of the inner cylinder 501 is no greater than that of the indent (216 or 217), when the horizontal cross-section of the indent (216 or 217) is circular.

The examples set forth above are provided to give those of ordinary skill in the art with a complete disclosure and description of how to make and use the claimed embodiments, and are not intended to limit the scope of what is disclosed herein. Modifications that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

What is claimed is:

1. A battery enclosure comprising of a flexible tubular battery housing with a top and bottom open end, and a top and bottom end plug, wherein the top end plug is attached to the top open end and the bottom end plug is attached to the bottom open end of the tubular battery housing, thus forming a sealed battery enclosure for housing a battery cell.

2. The battery enclosure of claim 1, wherein the flexible tubular battery housing is made from a flexible film.

3. The battery enclosure of claim 2, wherein the flexible film is a multi-layer laminate.

4. The battery enclosure of claim 1, wherein the top or bottom end plug is made from a polymer.

5. The battery enclosure of claim 1, wherein the top and bottom end plug are each independently tapered, cylindrical, or stepped.

6. The battery enclosure of claim 1, wherein the horizontal cross-sections of the top and bottom end plugs are each independently circular, semicircular, oval, triangular, square, or rectangular.

7. The battery enclosure of claim 1, wherein the horizontal cross-sections of the top and bottom end plugs are circular and the flexible tubular battery housing is a cylindrical tube for housing a cylindrical battery cell.

8. The battery enclosure of claim 1, wherein the horizontal cross-sections of the top and bottom end plugs are square and the flexible tubular battery housing is a tube in a square prism for housing a battery cell in the shape of a square prism.

9. The battery enclosure of claim 1, wherein the horizontal cross-sections of the top and bottom end plugs are rectangular and the flexible tubular battery housing is a tube in a rectangular prism for housing a battery cell in the shape of a rectangular prism.

10. The battery enclosure of claim 1, wherein the top or bottom end plug has an indent on either inner or outer surface of the end plug.

11. The battery enclosure of claim 1, wherein the top or bottom end plug further comprises an elaborate seal.

12. The battery enclosure of claim 11, wherein the elaborate seal is a Ziegler seal.

13. The battery enclosure of claim 1, wherein the top or bottom end plug further comprises one or more electrical posts.

14. The battery enclosure of claim 1, wherein the top or bottom end plug further comprises a post assembly.

15. The battery enclosure of claim 14, wherein the post assembly comprises an electrical post and a sealing nut, wherein the post assembly is secured to the plug by attaching the sealing nut to the outer end of the electrical post.

16. The battery enclosure of claim 14, wherein the post assembly further comprises a seal.

17. The battery enclosure of claim 16, wherein the seal is 0-ring or glass-to-metal seal.

18. The battery enclosure of claim 14, wherein the post assembly comprises an electrical post molded into the plug, to form the elaborate seal.

19. The battery enclosure of claim 14, wherein the post assembly comprises an electrical post crimped to the outer surface of the end plug.

20. The battery enclosure of claim 1, wherein the top or bottom end plug further comprises one or more safety devices.

21. The battery enclosure of claim 20, wherein the safety device is a positive temperature coefficient device.

22. The battery enclosure of claim 20, wherein the safety device is a current interrupt device.

23. The battery enclosure of claim 1, wherein the top or bottom end plug further comprises a fill hole.

24. The battery enclosure of claim 1 further comprising a center support with a top and bottom end, wherein the center support is attached to either the top end plug via its top end or the bottom end plug via its bottom end.

25. A battery comprising a battery cell and a battery enclosure of claim 1, wherein the battery cell is housed inside the battery enclosure.

26. The battery of claim 25, wherein the battery cell is a primary or secondary cell.

27. A method of attaching a top or bottom end plug having an indent on the outer or inner surface to one of the open ends of a flexible tubular battery housing, which comprises applying an outer cylinder to the side wall of the open end to be sealed, and an inner cylinder to the side wall of the indent of the end plug to be sealed, wherein the outer or inner cylinder is heated.

28. The method of claim 27, the axes of the outer and inner cylinders are parallel to the axis of the end plug to be sealed
